(19) United States
(12) Patent Application Publication
(10) Pub. No.: US 2018/0272190 A1
(43) Pub. Date: Sep. 27, 2018

(54) AGENT APPARATUS AND AGENT METHOD

(71) Applicant: Sony Corporation, Tokyo (JP)

(72) Inventors: Yasuko Miura, Stuttgart (DE); Teemu Veikko Tapani Pohjola, Stuttgart (DE); Vanessa Schelkens, Stuttgart (DE); Geert Premereur, Stuttgart (DE); Gaetan De Brucker, Stuttgart (DE); Johan Duyshaver, Stuttgart (DE)

(73) Assignee: Sony Corporation, Tokyo (JP)

(21) Appl. No.: 15/921,860

(22) Filed: Mar. 15, 2018

(30) Foreign Application Priority Data
Mar. 27, 2017 (EP) 17163069.2

(51) Int. Cl. A63B 24/00; G06F 15/18

(52) U.S. Cl. CPC A63B 24/0075; A63B 2024/0065; G06F 15/18; A63B 24/0062

(57) ABSTRACT

An agent apparatus has an interface configured to obtain fitness data and training instruction data and an artificial intelligence unit configured to provide an artificial coach by analyzing the fitness data and the training instruction data.

### TECHNICAL FIELD

The present disclosure generally pertains to an apparatus and a method, which can be used as an agent for providing an artificial coach.

### TECHNICAL BACKGROUND

Known fitness coaching services are typically provided by a personal trainer. However, a personal trainer might not be present in all cases, for instance, due to lack of availability during outdoor or in-house training. It is also known to provide fitness lessons or instructions, for example, over fitness applications, online videos, online web services or the like.

Furthermore, it is known that a fitness user manages his or her own fitness progress, determines personal fitness goals, plans training sessions, plans a diet, performs exercises, does vital tests, manages the overall health etc., for example, with the aid of applications or programs running on a computer or smartphone or the like. Current available fitness apps (i.e. fitness applications running e.g. on a smartphone) typically focus on providing fitness videos and online instructions for trainings with gym equipment.

Where a (real) personal coach provides and supervises a training plan for a user, there might be infrequent interactions between personal trainer and user, since the real personal coach can be limited to certain locations, such as an indoor gym facility, and might not always be available for monitoring of the training progress. This lack of holistic interaction between the user and the real personal coach may result in infrequent training sessions and discontinuation of the fitness training performed by the user.

Although there are available techniques for providing fitness coaching services, it is generally desirable to provide an improved apparatus and method for providing fitness coaching.

### SUMMARY

According to a first aspect, the disclosure provides an agent apparatus comprising an interface configured to obtain fitness data and training instruction data, and an artificial intelligence unit configured to provide an artificial coach by analyzing the fitness data and the training instruction data.

According to a second aspect, the disclosure provides an agent method, comprising obtaining fitness data and training instruction data, and providing an artificial coach by analyzing the fitness data and the training instruction data.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates an embodiment of a fitness agent apparatus, a user device and a coach device;

FIG. 2 illustrates an embodiment of two fitness agent apparatuses, a plurality of user devices and two coach devices;

FIG. 3 illustrates an embodiment of a fitness agent apparatus for running applications, a user device and a coach device;

FIG. 4 illustrates an embodiment of a fitness agent apparatus for running applications, a user device and a coach device;

FIG. 5 shows a flowchart of a method for simulating an artificial coach and generating personalized training plan;

FIG. 6 shows a flowchart of an embodiment of a method for generating training instruction data by a real personal coach; and

FIG. 7 shows a flowchart of an embodiment of a method for generating a personalized training plan and simulating an artificial coach by an artificial intelligence unit.

### DETAILED DESCRIPTION OF EMBODIMENTS

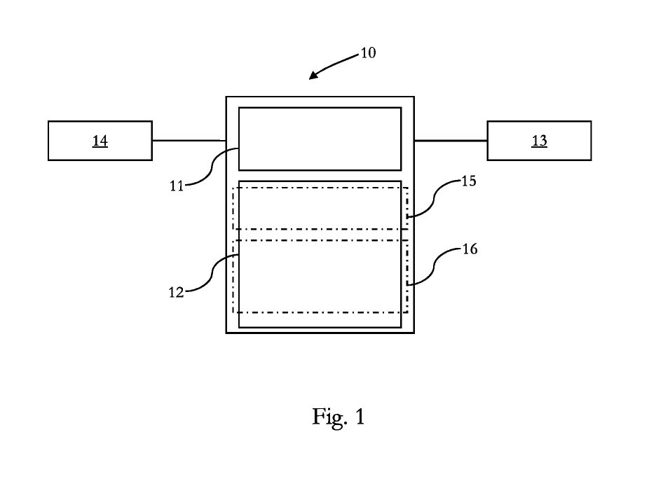

Before a detailed description of the embodiments under reference of FIG. 1 is given, general explanations are made.

As mentioned in the outset, generally, it is known to have a personal (human) coach, which, however, might not be present in all training situations. It is also known to provide fitness lessons or instructions, for example over fitness applications, online videos, online web services or the like.

Furthermore, where a real (human) personal coach monitors the training progress of a user via known online communication methods and provides feedback to the user, training sessions might be adjusted for a large group of users, such that fitness data and fitness progress of individual users might not be considered.

Thus, some embodiments pertain to an agent apparatus including an interface configured to obtain fitness data and training instruction data, wherein the fitness data may be obtained from at least one user device and wherein the training instruction data may be obtained from at least one coach device. The fitness data may be personal data for one or more individual users. The training instruction data may be general instruction data or it may also training data which are personalized for a specific user, e.g. by the human personal coach. Generally, the training instruction data may be associated with a specific user, such that they are thereby personalized for the specific user. Moreover, the training instruction data may be associated with the obtained fitness data, such that they are unique for the user from which the fitness data stem.

In embodiments, where the artificial coach is used by more than one user, the artificial coach may obtain training instruction data and/or fitness data, which are unique for each user. In such embodiments, the artificial coach may associate the training instruction data to the corresponding fitness data of a specific user. Thereby, for example, for each user an own artificial coach profile may be generated such that the artificial coach may also be personalized for a specific user.

The fitness data may include, for example, personal goal data, habit data, agenda data, sport preference data, diet data, medication data, training session plan data, training data, feedback data, training update data, medical data, and health data, etc.

The fitness data may be obtained upon request from the agent apparatus, it may be obtained on a regular basis (e.g. also periodic, at certain time intervals, certain points of time), and it may be obtained continuously, etc. It may also be obtained, when triggered by an event, for example, it may be obtained, when triggered by the user starting performing a training, when triggered by user starting user activities, when triggered by the artificial couch itself, or obtained, when triggered by the human personal coach by sending a message, etc.

Generally, in some embodiments, the fitness data may obtained from an application running on the user device or another device providing fitness data at least partially to the user device. The fitness data may be provided by measuring health parameters, movement parameters, location parameters, activity parameters or the like of a user, e.g. the user using the user device. Such parameters may be provided by one or more sensors, which can be located in the user device and/or one or more other devices communicating with the user device, e.g. wearables worn by the user. Sensors may be, for example, heart rate sensor, blood pressure sensor, location sensor (e.g. global positioning system sensor), temperature sensor, moisture sensor, etc.

The fitness data may be also derived from other information associated with the user, such as calendar data, location, messaging data, etc.

In the following, some examples for the fitness data and how they can be obtained are given without limiting the present disclosure to these specific examples.

For example, the personal goal data may include cardiovascular goals, strength training goals or the like. The personal goal data may be obtained via user input, user applications, user profile analysis performed by a respective device, which collects and analyzes user profile data or the like. It may be derived from messaging data or the like.

The habit data may include data of multiple performed activities by the user. It may be obtained from an application running on the user device or another device communicating, for example, with the user device, or by specific sensors included in the user device or located at the user or in the user's environment. Such specific sensors may include a global positioning system (GPS) sensor, a camera, tracking sensor or the like. The habit data may also be based on calendar information, messaging information or the like, which may be provided by corresponding applications running on a device, e.g. the user device or any other device used by the user.

The sport preference data may include user preferences for particular sports or particular fitness exercises, for example, such as specific gym exercises, football, skiing, golf, tennis and may be obtained by user input, analyzing user profile data, movement data provided by respective sensors providing movement data (or provided by a respective application) or the like.

The diet data may include nutrition data, diet goal data, die plan data, calorie data indication the total calories consumed over a predefined time interval. The diet data may be obtained by direct user input or through an application running on the user device, based on sensors detecting the user's activity (temperature, heart rate, blood pressure, etc.).

The medication data may include information about taken medication and may be obtained e.g. via user input, messaging data analysis, or the like, or based on sensors, such as a blood sugar sensor.

The training session plan data may include a description of the activities and instruments to guide the user toward the user fitness goal, such as list of exercises, workout routine, how long each exercises should be practiced, list of equipment, methods of instruction for each exercise and the like, and may be obtained by direct user input or by an application running on the user device (other device).

The training data may be information such as the training dumbbell weight, activity, speed, duration, method, and may be obtained by direct user input, and/or by a sensor in a smart fitness equipment, sensor(s) measuring health parameters of the user, such as heart rate, blood pressure, etc.

The health data may include data of a user health, such as heart rate in beats per minute, and maximum and/or minimum weight over a time interval, and may be obtained e.g. by a wearable sensor(s) or user input.

The feedback data are information about complimentary fitness exercises, a text, an audio message, etc., and may be obtained by direct user input.

The training update data may include data such as distance covered, since the last data acquisition, current wheel speed in a biking training, number of new steps since the last data acquisition, the time duration of a single activity, average, maximum, and minimum power generated while performing an activity and the like. It may be obtained, for example, by a wearable sensor(s), e.g. movement sensor, activity sensor, heart rate sensor, blood pressure sensor, etc.

The medical data may include data such as the user weight, body-mass-index data, etc., and may be obtained e.g. via user input or corresponding sensors which are able to provide the information.

The training instruction data may include at least one of: training plan data, training session data, training path data, repetition of exercise data, or data for instructing how to perform an exercise, e.g. based on voice data, text data, graphic data, etc. The training instruction data may be provided by a real personal coach via his coach device.

The coach device may also obtain the fitness data from at least one user device and present it to the real personal coach, who may monitors the fitness data, analyze the fitness data and further provide personalized training instructions. The training instruction may include a (personalized) training plan, a (personalized) fitness beacon, feedback, etc.

The agent apparatus includes an artificial intelligence unit to provide an artificial coach by analyzing the fitness data and the training instruction data. In some embodiments, the artificial intelligence unit simulates an artificial coach similar to a real personal coach based on the fitness data and the training instruction data.

In some embodiments, the agent apparatus (the artificial coach) may provide a (personalized) training plan, e.g. to a user to practice his or her fitness goals. The artificial coach may provide the (personalized) training plan and may perform real time monitoring of the training progress through data communication with the at least one user device, wherein the communication may be performed over the interface (e.g. over a respective portion of the interface or the like) before, during and/or after the training.

The training plan may be provided to the user, e.g. by displaying, or audio/video outputting (training) instructions, a training schedule and an image showing training exercises or the like to the user.

In some embodiments, the artificial coach may provide (training) instructions to the user similar to a real personal coach by analyzing the fitness data obtained, e.g. from a user device, and the training instruction data obtained, e.g. from a coach device of a human personal coach. Such instructions may be how to perform an exercise, which kind of exercise, which number of repetitions, length of the exercise, etc. The (training) instructions may be included in the training plan. As mentioned, such instructions may be outputted by displaying them, by audio outputting them and/or by video outputting them or by any other output technology.

In some embodiments, the agent apparatus may communicate with an application installed on the at least one user device or an application installed on a device of a real personal coach (also referred to as “coach device” herein). The artificial coach may provide information about the compliance with a user's lifestyle plan, for example, on the basis of processing of the fitness data obtained from the user device.

The fitness data may be obtained, for instance, from at least one application running on the user device and the training instruction data may be obtained from at least one application running on the coach device.

The agent apparatus may be an electronic device, a mobile electronic device (e.g. telephone, smartphone, laptop computer, tablet computer, etc.), a personal computer, a server, a robot, etc. The agent apparatus may also include, for example, a voice recognition technology, and it may be configured to react to commands received by voice from a user.

The agent apparatus may include one or more processors, one or more microprocessors, dedicated circuits, logic circuits, interfaces (e.g. for local network, wireless network, Bluetooth, infrared, etc.), user interfaces (e.g. keyboard, mouse, touchscreen, etc.), display means (liquid crystal display, (organic) light emitting diode based display, etc.). Moreover, the agent apparatus may further include applications to be connected to different user gears such as a headphone, a heart rate monitor, a wearable mobile training kit, a sport armband, a Bluetooth, an earphone, etc.

The agent apparatus may also be the user device or it may be integrated in the user device. In some embodiments, features of the agent apparatus may also be located on a coach device of a real personal coach (as mentioned above). In some embodiments, features of the agent apparatus may even be distributed between at least one user device and at least one agent apparatus.

The interface (unit) may include one or more processors, one or more microprocessors, dedicated circuits, logic circuits or the like, which may be, in some embodiments, specially designed for obtaining fitness data from at least one user device and the training instruction data from at least one coach device, whereby power consumption and processing time may be reduced compared to performing it on a multi-purpose processor, since by specially designing them for the purposes mentioned, complexity and thereby power consumption of such circuits may be reduced. Moreover, the interface may further include or may be a communication interface such as, a local area network, a wireless network, a Bluetooth, an infrared, etc., which may be specifically designed for communication with an application running on the user device and/or on the coach device and/or on the agent apparatus. Moreover, the interface (or a further interface) may be configured to communicate with other circuits included in the artificial intelligence unit circuitry. The interface may include one or more interface portions, wherein different interface portions may have different tasks, e.g. for communicating with the coach device, with the user device and/or different portions may also have different logical tasks, such as communications of different data types, etc., and/or different interface portions may use different communication technologies, wire/wireless, infrared, etc. and/or different communication channels.

The artificial intelligence unit may include one or more processors, one or more microprocessors, dedicated circuits, logic circuits or the like, which may be, in some embodiments, specially designed for providing an artificial coach by analyzing the fitness data and the training instruction data. In some embodiments, power consumption and processing time may be reduced compared to performing it on a multi-purpose processor, since by specially designing them for the purposes mentioned, complexity and thereby power consumption of such circuits may be reduced. Moreover, the artificial intelligence unit circuit may include an interface, e.g. for communication via local area network, a wireless network, Bluetooth, infrared, etc., which may be specifically designed for communication with applications running on the fitness agent apparatus or on another apparatus. Furthermore, the interface may be configured or specifically designed to communicate with other circuits included in the circuitry and/or in the agent apparatus.

The agent apparatus or its artificial intelligence unit provides and/or may be further configured to provide an artificial coach, e.g. by simulating a real personal coach or predefined real personal coach characteristics, based on the obtained fitness data and the training instruction data by using known machine learning algorithms. Personal characteristics may include, for example, preference for specific exercises, training plans, which are specific for the personal coach, reactions of the personal coach on predefined medical parameters, e.g. cheering for the user when detecting that a medical parameter is over/under a threshold, e.g. the heart rate exceeds/is below a threshold, or using specific relaxing exercises, interval trainings, etc. As mentioned, the artificial coach may be able to provide training instructions, such as how to perform an exercise, which kind of exercise, which number of repetitions, length of the exercise, etc., and/or the artificial coach may monitor the training of the user, e.g. based on the fitness data and may instruct the user accordingly, e.g. by instructing to do the exercise faster/slower/differently, perform another exercise, stop the exercise, etc.

In some embodiments, the artificial intelligence unit is configured to provide the artificial coach, e.g. based on machine learning algorithms, while in other embodiments the machine learning algorithms may be performed at another location, e.g. on a remote server or the like, which provides artificial coach data, wherein the artificial intelligence unit may provide the artificial coach on the basis of the obtained artificial coach data. For example, the remote server may obtain the fitness data and the training instruction data and may perform a machine learning algorithm which outputs artificial coach data which can be used by the agent apparatus for providing the artificial coach.

Typical machine learning algorithms, which are used alone or in combination in some embodiments for providing the artificial intelligence of the artificial intelligence unit are: decision tree learning, association rule learning, artificial neural networks, deep learning, support vector machines, Bayesian networks and the like. Moreover, in some embodiments, personalized training instruction data may be generated by the artificial coach provided by the machine learning algorithms.

For example, on the basis of exercise instructions represented by the training instruction data and a progress/amendment in the fitness of the user represented by the fitness data a machine learning algorithm can learn which kind of exercise, which number of repetitions, length of the exercise, etc. provides a respective training success and fitness progress for the user. Another example is that it is learned on the basis of concrete instructions provided by the real personal coach represented by the training instruction data during a training session how the user has to train in order to achieve certain goals. It can also be learned, for example, on the basis of a personal goal represented by the fitness data and a respective training program provided by the real personal coach and represented by the training instruction data, with which kind of exercises included in the training program and with which kind of training plan or training schedule, for example, such a goal can be achieved. Of course, as it is apparent to the skilled person, there are many other possibilities for learning and thereby providing the artificial coach, and the present disclosure is not limited to the example given above.

An application may be a software program which can be executed e.g. by a processor of the agent apparatus, the user device and/or the coach device. Furthermore, the fitness data, the training instruction data, the personalized training plan data, and the fitness beacon data discussed further below may be generated by an associated application. In some embodiments, the fitness data, the training instruction data, the personalized training plan data and the fitness beacon data can only be interpreted by the application which generated them, for example since the meaning of the specified generated data may only be known by the associated application which generated the data. Moreover, in some embodiments, the agent apparatus or its artificial intelligence unit may be configured to determine a training progress based on the fitness data and the training instruction data and may further determine a fitness progress based on the evaluation of the fitness data.

In some embodiments, the agent apparatus provides at least one (training) instruction, based on a fitness beacon. The fitness beacon may be obtained, e.g. included in the training instruction data, from the coach device. The fitness beacon may also be generated by the artificial coach, i.e. the artificial intelligence unit. The instruction may be transmitted to the user device, for being output by the user device or it may also be output be the agent apparatus. As mentioned, the output may be visual, audio, video or the like. Hence, the fitness beacon may be defined by the real personal trainer, by the artificial coach or by both.

The instruction may instruct the user to perform a fitness activity, which may be personalized, e.g. by the real personal coach or by the artificial coach. The instruction may be used for presenting the fitness activity to the user (e.g. the instruction may be or may include presentation material), and, thus, may include a text message, a video message and/or an audio message, one or more pictures describing the fitness activity, video data showing the fitness activity, or it may also be used for generating vibrations for indicating a predefined fitness activity, controlling blinking of LEDs at the user device or at the agent apparatus, or the like. The instruction may also be an instruction to alter the personal trainer, meet a person, use a training means (bike, stone, etc.), to go in a certain direction, make repetitions of an exercise, rest for a while, look into the landscape, meet a person, sing, etc.

The (training) instruction, which is provided, e.g. to the user, may be included in the fitness beacon. For this purpose, the fitness beacon may be a digital message, a data file or even a (small) program (applet or the like), which includes an instruction portion for storing instruction data representing the at least one instruction. If the fitness beacon is a program, it can be carried out the agent apparatus and/or by the user device.

Furthermore, the fitness beacon may include a training event. The training event may include a trigger event and a trigger condition. The trigger event may include at least one of: location, point of time, training exercise, fitness route, fitness program, fitness activity, weather condition, and presence of person or the like. The trigger condition may include a condition, which may be fulfilled, based on the trigger event, and, if the condition is fulfilled, the instruction may be provided. For example, if the user reaches the location stored in the trigger event, the associated instruction is provided (e.g. by outputting, transmitting to the user device and outputting by the user device, etc.), as will also be discussed further below.

More generally, in some embodiments, when the training event is detected, the instruction may be provided. For instance, as mentioned, if the user reaches the location defined in the trigger event of the training event and thereby meeting the trigger condition, which can be determined, for example, based on location data (or fitness data) obtained from the user device, the associated instruction is provided, since the trigger condition (“reaching location”) is met.

In some embodiments, for each trigger event and/or trigger condition a specific instruction is provided. For instance, a first instruction is associated with a first trigger event and a first trigger condition, a second instruction is associated with a second trigger event and a second trigger condition, etc.

Hence, the training event may be detected, based on the training instruction data (which may include the fitness beacon) and/or the fitness data, which may include the location.

The fitness beacon may be personalized, for example, since the instruction and/or the training event may be personalized for a specific user. Hence, for example, the real personal coach may define the training event, e.g. personalized for a specific user. Here, the real personal couch may define the trigger event and the trigger condition. Similarly, in some embodiments, the artificial coach may set the trigger event and/or the trigger condition, for example, personalized for a specific user.

The fitness beacon may be assigned to a specific fitness route, training or program of a user. Hence, in some embodiments, the fitness beacon may include multiple trigger events and/or multiple trigger conditions for the specific fitness route, the training or program of the user. For example, the trigger events may be different locations of the fitness route, different exercises or the like. Hence, if the location is reached, the exercise is performed, i.e. the trigger condition is met, the respective instruction is provided. In other embodiments, multiple fitness beacons may be assigned to a specific fitness route, training or program of the user, e.g. based on the different trigger events associated with the fitness, the training or the program.

As mentioned, when the agent apparatus detects the training event, the associated instruction(s) may be presented to the user, e. g. via the user device and using, such that the user can perform, for example, the fitness activity represented by the instruction(s).

The fitness activity represented by the instruction(s) of the fitness beacon, may be personalized and it may be a specific sports challenge (e.g. doing exercise in a predefined time, reach a specific location within a predefined time, do another exercise, e.g. climbing, jumping, sit-ups, etc.) or surprise task (e.g. jumping, press-ups, sit-ups, push-ups, etc.), or the like.

As mentioned, the instruction(s) of the fitness beacon may be provided, based on the training event, wherein the training event may include trigger event and a trigger condition.

An example of a trigger event is a location, wherein the location may be a predefined location within the training course or a location where the user is currently located, or the like. The trigger condition may be to detect the location, which may be detected, for example, by the agent apparatus or by the user device, by comparing the current location of the user with the location of the trigger event. The current location of the user may be detected, based on a location sensor, for example, global positioning system sensor or the like integrated in the user device (or wearable or the like worn by the user). This detection may be performed, for example, by the user device and/or by the user agent, e.g. based on location data obtained from the user device.

Another example for the trigger event is a point of time, which may be a specific point of time on the day or it may be defined by a specific time period after start of the training, or the like. The trigger condition may be to detect the point of time, which may be detected, for example, by the agent apparatus or by the user device, based on a current time.

Another example for the trigger event is a training exercise, which may be running, jumping, push-ups, etc. This kind of trigger event may be detected by using one or more sensors, e.g. of the user device, a wearable or the like which typically include multiple sensor, which are able to detect a movement pattern of the user on the basis of which performing of a specific training exercise may be detected. This detection may be performed, for example, by the user device and/or by the user agent, e.g. based on fitness data obtained from the user device.

Another example of the trigger event is a fitness route, which may include specific type of exercises, training locations, highlights in the landscape, landscape information (e.g. hills, wood, etc.), etc. The associated trigger condition may be to detect the specific type of exercises, training locations, highlights in the landscape, landscape information, e.g. based on using sensors of the user device and/or of other sensors worn by the user. This detection may be performed, for example, by the user device and/or by the user agent, e.g. based on fitness data obtained from the user device.

Another example of the trigger event is a fitness program, which may include specific exercises, information about the health/training status of the user (e.g. heart rate, breath rate, blood pressure, etc.), etc. The associated trigger condition may each be to detect the specific exercises, health/training status of the user (e.g. heart rate, breath rate, blood pressure, etc.), e.g. based on using sensors of the user device and/or of other sensors worn by the user. This detection may be performed, for example, by the user device and/or by the user agent, e.g. based on fitness data obtained from the user device.

Another example of the trigger event is the fitness activity, which may also include specific exercises, current exercise (e.g. running, biking, swimming, etc.), etc. The associated trigger condition may be to detect the specific exercise. This kind of trigger event may be detected by using one or more sensors, e.g. of the user device, a wearable or the like which typically include multiple sensor, which are able to detect a movement pattern of the user on the basis of which performing of a specific training exercise may be detected. This detection may be performed, for example, by the user device and/or by the user agent, e.g. based on fitness data obtained from the user device.

Another example of the trigger event is a weather condition, which may include temperature, moisture, raining, snowing, sun shining, etc. The associated trigger condition may be to detect the specific weather condition, e.g. based on weather data received from the internet or based on sensor data from any suitable sensor from the user device or any other sensor to which the user device and/or the agent apparatus is coupled. This may detected by the user device and/or the agent apparatus, based on the weather data.

Another example of the trigger event is the presence of a person, which may include the presence of another user who trains and/or the presence of a trainer, an acquaintance, etc. The trigger condition may be detection of the presence of the person, e.g. based on an image made with a camera of the user device, based on receiving a user identification from a user device of the person, or the like.

The detection may be performed by the user device or by the agent apparatus, e.g. based on respective data obtained from the user device.

The fitness beacon may e.g. be provided by the real personal coach via the coach device as part of the training instruction data, e.g. by defining an instruction (or multiple instructions), e.g. representing a fitness activity, as discussed above, and associating it with a training event (or multiple training events), as mentioned, e.g. a location, time, activity. For instance, the real personal coach, identifies a specific location as trigger event, such that if the location is reached by the user (which is the trigger condition), an instruction, e.g. “run up the hill”, is provided to the user.

Such a fitness beacon may be transmitted to the agent apparatus and/or the user device, such that the agent apparatus and/or the user device can output the instruction, e.g. representing the fitness activity, of the fitness beacon to the user, when the respective training event is detected. The output can be performed by displaying information on a display of the user device, and/or by audio output via a loudspeaker of the user device or the like, as also mentioned above.

For example, the agent apparatus (its artificial coach) or the real personal coach may know the landscape of the usual fitness route and therefore suggests to put a beacon in a suitable place (a beautiful nature spot, a sightseeing location, a location where the user is likely to meet other trainees etc.). In some embodiments, the fitness beacon is placed automatically and/or dynamically e. g. based on the current weather conditions, the presence of other trainees, the shape of the user in the specific session, the chosen route etc.

In some embodiments, the real personal coach provides one or more instructions, e.g. fitness activities, to the coach device, and the agent apparatus (its artificial coach) suggests to the real personal coach, via the coach device, one or more suitable (personalized) training events, including respective trigger events and trigger conditions. This can be done, for example, by the artificial coach, based on a given fitness route, wherein the artificial coach identifies trigger events, e.g. trigger locations, in the fitness route and presents them to the real personal coach, e.g. via the coach device. Then, the real personal coach may associate respective instructions with the trigger events (i.e. locations) presented to him and defines the trigger condition, e.g. detecting that the user has reached the predefined locations.

Thus, the real personal coach may create one or more fitness beacons by associating each of the provided one or more instructions (e.g. fitness activities) with one (or more) of the suggested training events.

In other embodiments, the real personal coach (or the user) may provide, for example, a fitness route, e.g. via the coach device, to the agent apparatus. Then the artificial coach may provide training events by analyzing the fitness route to the real personal coach (and or the user) such that then, based on the training events, the real personal coach can associate respective (training) instruction(s) with each training event.

For generating personalized suggestions, the artificial coach may use the user's fitness data and/or other data about the user and/or training instruction data and/or data about preferences of the user and/or other data describing the user's current environment. This can also be used during a fitness training, for example, where the artificial coach may obtain information about the landscape of the user's usual fitness route, information about contact persons, user preferences, weather conditions, etc.

For example, the artificial coach may learn if the usual training route of the user includes a beautiful nature spot or a view point, such that then the artificial coach may suggest a training event like “the user reaches the beautiful nature point or view point”. Such nature spots or view points may also be presented to the real personal coach, who then may associate them with respective (training) instructions (or vice versa).

In another example, the user does not like to train alone, such that then the artificial coach may suggest training events connected with a location, where the user is likely to meet other trainees, etc.

Alternatively, the artificial coach may associate a fitness activity provided by the real personal coach automatically and/or dynamically with a training event without further involvement of the real personal trainer, based on the fitness data and/or other data describing the user's current environment during a fitness training, e. g. the current weather conditions, the presence of other trainees, the shape of the user in the specific session, the chosen route etc.

Hence, the artificial coach may associate the fitness activity or other training instructions, which it may also have learned based on training instruction data, automatically or dynamically with training events, which it may have learned also on training instruction data and/or by analyzing user habits.

For instance, the artificial coach may also automatically recognize during a fitness program performed by the user that the user reaches a certain location, e.g. a lake, and associates this training event with the instruction “Go swimming!” (or vice versa).

Another example is that the artificial coach detects that the outdoor temperature is very high (e.g. trigger event) and, thus, instructs the user to run more slowly (instruction) if the heart rate reaches a certain threshold (trigger condition).

Another example is that the artificial coach detects that the user changes from running to walking (trigger event) and if the heart rate falls below certain threshold (trigger condition), the artificial coach instructs the user to run again, etc.

In some embodiments, the artificial coach may prompt the real personal coach, e.g. via the coach device, to specify a certain range for individual fitness activities, or provide alternative fitness activities for a single fitness beacon, so that the agent apparatus can dynamically adapt the challenges (instructions) within that range or choose one of the alternative fitness activities, based on current fitness data or data about the user's current environment, e. g., based on the daily shape of the user, which is known, for example, based on the fitness data obtained from the user device of the user.

Such ranges or alternatives for individual fitness activities may also be suggested to the real personal coach via the coach device, or actually chosen, by the artificial coach, e.g. based on current and past fitness data and training instruction data.

In some embodiments, the artificial coach performs machine learning after a training phase, performs learning about habits, fluctuations in the (fitness) activities, etc.

Moreover, the real personal coach (or the artificial coach) may also provide certain challenges in the training instruction data, which the agent apparatus may allocate and put into the provided fitness beacon.

The artificial coach may also provide (or generate) a fitness beacon, or at least training events and/or training instructions by itself, based on the training instruction data and/or the fitness data.

In some embodiments, the interface (i.e. a specific interface portion of the interface) of the agent apparatus and/or a specific beacon interface included in the agent apparatus may be able to assist the creation of a fitness beacon by providing respective creation data to the real personal coach, e.g. via the coach device, or by the coach device connection to the specific beacon interface of the agent apparatus. The provision of the fitness beacon creation data may be based on the training instruction data and/or on the fitness data. For instance, if the artificial coach learns from past training instruction data that the last trainings were “running along a specific fitness route” and the fitness data indicates a certain fitness level of the user, the artificial coach may provide creation data including more challenging obstacles (e.g. hills or the like which fit to the fitness route”) than in cases where the fitness data show that the user is not able to manage hills, etc.

The fitness beacon creation data may represent one or more predefined beacon templates, which may include predefined locations, exercises, etc. which can be selected by the real personal coach.

In some embodiments, a user chooses a real personal coach and communicates with the coach through the agent apparatus. In such embodiments, the agent apparatus may transmit the fitness data to the personal coach, e.g. to the personal coach's coach device, whereby the real personal coach may provide personalized training instruction data and the fitness beacons to the agent apparatus. As mentioned, the training instruction data and the fitness beacon (data) may be obtained via the interface.

In some embodiments, a user may book a training session with a real personal coach via communication through the agent apparatus (e.g. mobile communication, messaging, or the like), for example, for a live training, or the user may schedule on demand for instance, for an online fitness training, or several users may connect to a real personal coach and may book a training session together. The agent apparatus may be configured to communicate via voice, email, text messages, or any other type of communication.

In some embodiments, the agent apparatus is configured to connect the user to the real personal coach for providing personalized training instruction data, before, during and after training. Furthermore, the interface may provide communication for example between an application running on the user device and an application running on the coach device.

The agent apparatus may further include a user authentication feature, for instance, a touch ID, a facial recognition sensor, and the like, and, thus, may be capable of identifying the user. Moreover, the agent apparatus may be configured to be used in a smart gym equipment, e.g. for providing and obtaining data from a sensor placed in the equipment, for instance, obtaining a heart rate from a pulse sensor placed in an exercise machine.

Furthermore, the artificial coach may monitor the fitness data and may determine a training status. Based on the training status, fitness data may be displayed on a display, e.g. of the agent apparatus, wherein displaying the fitness data or a representation of the fitness data may be based, for example, on at least one of: a text, an icon, graphical representation of an item, sound, vibration of the device, or the like. The fitness data may be displayed by an application running on the agent apparatus, wherein the application may receive the fitness data.

The artificial coach may generate training instruction data based on a data generation algorithm, which uses the obtained fitness data from the user device and the training instruction data from the coach device as input. The data generation algorithm may be based on a Bayesian network, on clustering model or other approaches, which are known to the skilled person, and which are also mentioned above with respect to machine learning.

In some embodiments, the generation of the training instruction data by the artificial coach provided by the artificial intelligence unit is performed based on the obtained fitness data of different users performing the same fitness training. Thereby, a large data set of the fitness data may be obtained and a (global) machine learning algorithm may be performed using the large data set of the fitness data and the training instruction data as input data. As mentioned, such a global machine learning algorithm may also be performed at another location, e.g. a remote server or the like, which provides artificial coach data via the interface to the agent apparatus.

In some embodiments, the user does not need to organize the fitness data, since, for example, the fitness data, which may include at least one of movement data, repetition data, trainings data and fitness data, are at least partially transmitted automatically.

In some embodiments, the artificial coach is used for generating training instruction data, which may be provided, for example, as a computer program or training program, which is performed by the artificial intelligence unit on the agent apparatus.

As mentioned, the agent apparatus may collect the fitness data from the user device and the training instruction data from the coach device and may, for example, transmit the obtained data to an agent apparatus or the like, on which a machine learning algorithm or the like is performed in order to provide the artificial coach.

In some embodiments, no trace of the fitness data and the training instruction data is left on, for example, a permanent storage outside the agent apparatus (e.g. in the cloud). In some embodiments, the fitness data and the training instruction data are only needed during running of the artificial intelligence algorithm providing the artificial coach and they may be deleted afterward.

As discussed above, in some embodiments, only the respective applications themselves know the “meaning” of their fitness data, the training instruction data and the associated data they pass to an entity, agent apparatus, agent platform or the like performing the artificial intelligence algorithm. Hence, there may be no need to trust in the integrity of the entity, agent apparatus, agent platform, etc.

In some embodiments, an application programming interface (API) is provided, which may be provided by the artificial intelligence unit of the agent apparatus and/or which may be included in the interface or any other unit of the agent apparatus and/or which may be part of an agent platform. Over the API, third party application providers may provide the fitness data and the training instruction data, e.g. for simulating an artificial coach. Additionally, over the API, for example, an application may receive the fitness data and the training instruction data on the basis of which a personalized training instruction data may be generated.

In some embodiments, the interface is configured to obtain fitness data from at least one of: biometric sensor, such as a heart rate monitor, a blood pressure monitor, a calorie monitor, a grip strength monitor, a movement monitor, etc.

In some embodiments, the artificial intelligence unit is further configured to monitor the fitness data received from, for example, a mobile phone, smartphone, an activity tracker, a wearable device or etc., when the user is training outdoors, or from, for example, a home agent device when the user is training in-house. The home agent device may also include physical sensors and may be worn by the user and may provide, for example, movement data of the user, when the user trains in-house. Moreover, the agent apparatus may further include a display for displaying the fitness data received from the user device. Generally, home agent devices are known, and they also may include face recognition, voice recognition and the like, and multiple sensors, cameras, etc. in order to track user activities, assist users in controlling their environment (light switches, multimedia devices, etc.), performing ordering of good, etc.

In some embodiments, the user device has a global positioning system (GPS) receiver for finding the user location, and the agent apparatus may suggest a possible training or training session based on the user location, which may be performed in a specific area around the detected user location, wherein the training may be associated with the specific area and might be, for example, jogging, hiking, biking, skiing, etc.

In some embodiments, the agent apparatus may further be connected to an online interactive public forum in which users may review postings and may be able to post, e.g., useful fitness training ideas.

In some embodiments, the agent apparatus may provide workout and customized fitness programs designed, for example, by skilled athletes and a user may share his/her fitness results with other users, or the agent apparatus may further include an additional application for comparing the user's progress with, for example, other athletes or users performing an identical or similar training.

In some embodiments, the agent apparatus analyzes the obtained data and may provide feedback for helping the user to meet a fitness goal. The agent apparatus may enable the user in building an own workout routine by modifying the training plan based on the obtained feedbacks and/or it may enable the user to access the training data of other users, e.g. skilled and knowledgeable athletes performing the same or similar training, for providing a respective training plan or workout routine.

The agent apparatus may output via an output, e.g. display, loudspeaker, vibration means, etc. training instructions to the user for performing exercises, as mentioned above.

In some embodiments, the agent apparatus further includes a database of different exercises, for example, fitness training videos, yoga training video, meditation data, diet information, an online forum, a daily, a weekly or a monthly workout calendar, where a user may plan to target core muscles, such as chest, arm, back, leg, cardio, etc.

In some embodiments, the agent apparatus further includes an application for developing an inactive mode (e.g. the user can select a pause/resume button). If the user e.g. does not have enough time to complete a fitness session, the artificial coach changes into the inactive mode. The agent apparatus may be able to obtain the fitness data at another time, e.g. when the user is active again and the artificial coach changes into active mode.

In some embodiments, the agent apparatus is further configured to track, for example, a number of repetitions of a specific training exercise. For example, the agent apparatus includes an application for automatically obtaining movement data or the like from a movement sensor, which is, for example, included in a wearable device (e.g. fitness equipment) worn by the user. Thus, the user may not need to remember the repetitions mentally or may not need to make notes during exercises. The artificial intelligence unit may automatically keep track of training events, such as, type of the exercises, number of the performed repetitions, rest time between repetitions and the like and may further analyze the consistency of the performed exercise.

In some embodiments, the agent apparatus may further include an application for plotting or displaying the fitness data. The artificial intelligence unit may keep track of, for example, recent training exercises, such as bicycling, running, number of taken steps, etc. The artificial intelligence unit may also track training related data, such as distance, elevation, speed, burned calorie, heartrate and power, and may evaluate and display or plot such tracked data in a graphical presentation.

In some embodiments, the agent apparatus may further include an application, e.g. running on its processor, that is able to track a running pace and may be able for example to pick a song that matches the specified training.

In some embodiment, the agent apparatus may further include an application for measuring the body response, e.g. hart rate, blood pressure, to a specific workout or training exercise and may, for example, confirm that the user performs that training at the appropriate intensity or it may inform the user, for example, to decrease or increase the intensity.

Some embodiments pertain to an agent method, including obtaining fitness data and training instruction data, and providing an artificial coach by analyzing the fitness data and the training instruction data, as discussed above. The agent method may be performed by the agent apparatus as discussed herein, by one or more processors, by a circuitry, by logic circuits and the like, by an electronic device (computer, mobile phone, smart phone, tablet pc, pc, server, etc.) or any other device which is capable of electronically performing a method.

As discussed, the fitness data may include at least one of: training data, personal goal data, training session plan data, training location data, training update data, feedback data, sport preference data, habit data, agenda data, diet data, medication data and health data.

The agent method may include providing a personalized training plan, as discussed above, which is specified for a user.

The agent method may further include providing an instruction (or multiple instructions), based on a fitness beacon, as discussed above. As discussed above, the fitness beacon may include the instruction and a training event being associated with the instruction, wherein the instruction may be provided, when the training event is detected

The agent method may further include communicating with at least one of user device to obtain fitness data and coach device to obtain training instruction data, as discussed above.

The agent method may further include determining a training progress based on the fitness data and the training instruction data, as discussed above.

The agent method may further include evaluating fitness data for determining a fitness progress.

The agent method may further include simulating a real personal coach and generating training instruction data, as discussed above, wherein the real personal coach is simulated by the artificial coach provided by the artificial intelligence unit.

The agent method may further include monitoring the fitness data for determining a training status. As discussed, the fitness data may represent medical information of a user, such as heart rate, blood pressure, etc. and the basis of these data a training status can be determined.

The agent method may further include displaying the fitness data. Thereby, a user or a personal trainer can see, for example, the fitness status and progress of the user.

The methods as described herein are also implemented in some embodiments as a computer program causing a computer and/or a processor and/or a circuitry to perform the method, when being carried out on the computer and/or processor and/or a circuitry. In some embodiments, also a non-transitory computer-readable recording medium is provided that stores therein a computer program product, which, when executed by a processor and/or a circuitry, such as the processor and/or a circuitry described above, causes the methods described herein to be performed.

Returning back to FIG. 1, an embodiment of a fitness agent apparatus 10 is illustrated.

The fitness agent apparatus 10 has an interface 11 and an artificial intelligence unit 12. The interface is connected to a user device 13 and a real personal coach device 14 (also referred to as “coach device 14” in the following). The artificial intelligence unit 12 has a processor 15, which is connected to a storage 16 and the interface 11. The storage 16 includes a random access memory (RAM) and a flash storage.

The interface 11 communicates with a mobile telecommunication system, e.g. LTE, GSM or the like, before, during and after training. It is also provides access to a local area network (LAN) and to perform a wireless communication with a wireless local area network. Additionally, it may, for example, communicate over Bluetooth. Thereby, the fitness agent apparatus 10 can establish a connection to the internet. Hence, the fitness agent apparatus 10, the user device 13 and the coach device 14 may communicate over a network e.g. LAN, Wifi, etc. and/or the internet with each other.

The fitness agent apparatus 10 is able to “connect” the user device 13 and the coach device 14 to each other for obtaining training instruction data by communicating bidirectional with the user device 13 and the coach device 14. Thereby, e.g. during training, the real personal coach is able to monitor the training progress of the user of the user device 13, e.g. by monitoring respective fitness data transmitted from the fitness agent apparatus 10 to the coach device 14, and the real personal coach and the user may communicate with each other at any time, wherein the communication is handled by the fitness agent apparatus 10.

Furthermore, when an exceptional situation occurs during a training session, the real personal coach is specifically notified by the agent apparatus 10. When the coach device 14 is not available, the fitness agent apparatus 10 carries out the role of the personal coach by, for example, providing a personalized training plan and similar support as a real personal coach, wherein this task is performed by the artificial coach provided by the artificial intelligence unit 12.

As discussed above, the artificial intelligence unit 12 provides an artificial coach. In the present embodiment, the artificial coach is provided based on machine learning algorithms including an artificial neural network, which uses fitness data, obtained from the user device 13, and training instruction data, obtained from the coach device 14 as input. For example, on the basis of exercise instructions represented by the training instruction data and a progress/amendment in the fitness of the user represented by the fitness data, the artificial neural network can be trained. Thereby, an artificial coach can be provided. Of course, any type of information represented by the training instruction data and the fitness data can be used for training of the artificial neural network for providing the artificial coach.

The entire fitness agent apparatus 10 including the interface 11, the processor 15 and the storage 16, may form a circuitry as discussed herein.

The fitness agent apparatus 10, the user device 13 and the coach device 14, all have an output unit, which is an exemplary display based on LED-technology and is configured as a touch screen without limiting the present disclosure in that regard, and/or loudspeaker for outputting voice instructions, tones, music, etc., a vibration means, etc.

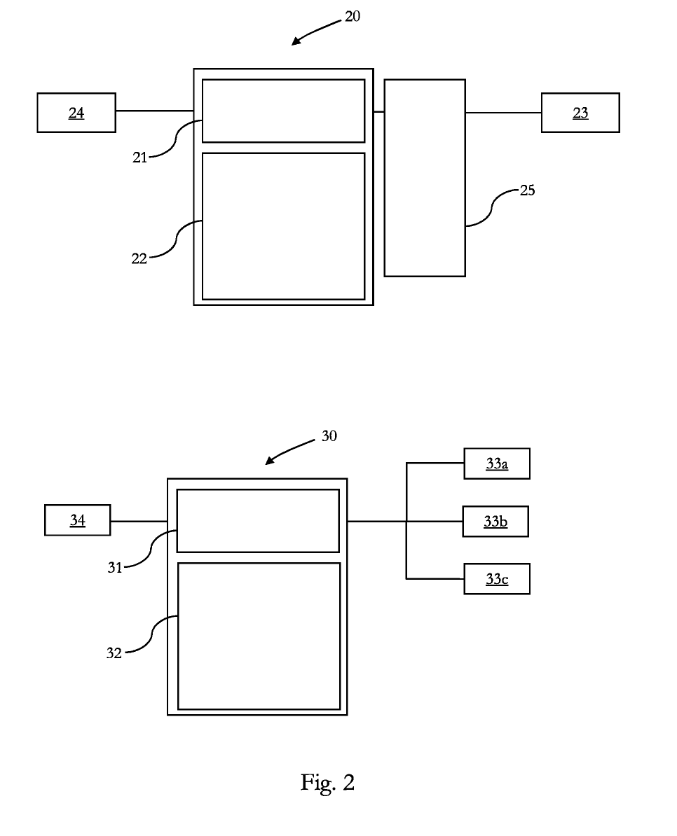

FIG. 2 illustrates two embodiments of a fitness agent apparatus, namely a fitness agent apparatus 20 on the upper side and a fitness agent apparatus 30 on the lower side, wherein both fitness agent apparatus 20 and 30 are similar in its functionality and similar to fitness agent apparatus 10 of FIG. 1.

The fitness agent apparatus 20 has an interface 21 and an artificial intelligence unit 22. The interface 21 connects the apparatus to a user device 23 and to a real personal coach device 24, as discussed above, wherein the user performs in-house training. The fitness agent 20 may connect the user and the coach to each other and may keep them connected before, during and after training, as also discussed above. The interface 21 is also configured to obtain data from a home agent device 25, which is an agent device having sensors and is worn by the user and which provides movement data of the user, when the user trains in-house.

The home agent device 25 may also be used to track and monitor the progress of the training such as stretching by providing respective movement data to the fitness agent apparatus 20.

The fitness agent apparatus 30 has an interface 31 and an artificial intelligence unit 32, as discussed above, wherein the interface 31 communicates with a plurality of user devices including a smart home electronics user devices 33a, a wearable and mobile technology user devices 33b, and a smart gym equipment user devices 33c, and also with a real personal coach device 34. Moreover, when the training is outdoors, e.g., a mobile phone or an activity tracker may be used for monitoring and tracking the user and the associated training progress.

Furthermore, the interface 21, 31 communicates with the user device 23, 33 and the coach device 24, 34 for training plan updates and providing feedbacks, before, during and after training. Moreover, the interface 21, 31 may obtain a fitness beacon from the real personal coach device 24, 34.

In the following an use case of the fitness agent apparatus 20, 30 is discussed, based on the embodiment as illustrated in FIG. 2.

Before a training session starts, a real coach named Justin signs up on the fitness agent apparatus 20, 30 through entering his personal data on his coach device 24, 34, which communicates with the fitness agent apparatus 20, 30. Justin may include a “personalized sound clip” to be used by the fitness agent apparatus 20, 30, for example, during the training session of a user.

Likewise, an arbitrary user named Mark in this embodiment also signs up via an application running on his user device, e.g. a mobile device 23, 33b and searches for a personal trainer or directly chooses his personal trainer.

The search for the personal trainer may be executed based on for, example, a location (e.g. of the user), a training specialty, the gender, a personality trait, etc.

Next, the fitness agent apparatus 20, 30 matches the coach and the user and may connect them to each other by establishing a communication via its interface 21, 31.

The fitness agent apparatus 20, 30 may send a notification message to the coach device 24, 34, such as “Mark has signed up for the service”, and a notification message to the user device 23, 33b, such as “Meet Justin, he will be your personal trainer”.

Furthermore, Mark and Justin may communicate to each other through or via the fitness agent apparatus 20, 30, and they may arrange a live discussion session and may have a video call together. They may have a discussion about Mark's fitness goals, training preferences, performed exercises, and the like. Moreover, the real personal coach device 24, 34 also receives the fitness data, which the fitness agent apparatus 20, 30 has collected, e.g. from earlier training sessions of Mark, and Justin creates a fitness training instruction plan for Mark represented by training instruction data transmitted to the fitness agent apparatus 20, 30.

The training instruction data may include, for example, a list of training activities, a schedule for each training, training routes including a (personalized) fitness beacon, a gym training session, guidance on exercises, etc.

Next, the interface 21, 31 on the fitness agent apparatus 20, 30 may receive the training instruction data from the coach device 24, 34 and may notify Mark with a message such as “Justin has created the plan for you. Let me share it”.

During a training session, for example, Mark goes running and wears at least one activity sensor and carries the mobile device 23, 33b. The artificial coach of the fitness agent apparatus 20, 30 having the training plan, based on the training instruction data received from the coach device 24, 34, detects Mark's activity, running in this case, and executes the training program and may notify Mark with an audio message such as “Hi Mark. For today I have planned you HIIT training” and may use the recorded personalized sound clip received from Justin.

In addition, the artificial coach of the fitness agent apparatus 20, 30 may notify Justin with a message such as “Mark has started his HIIT training. I will share his progress to you”. Furthermore, Justin begins monitoring the training progress and may send a message to Mark as “You are doing great” over the fitness agent apparatus 20, 30 and the artificial coach.

Moreover, during progress monitoring, the artificial coach of the fitness agent apparatus 20, 30 notifies Justin, when an exception is detected, for example, with a message such as “Mark's heart rate is above the thresholds”, wherein the fitness agent apparatus 20, 30 (or the artificial coach) detects the exception based on fitness data of Mark, which are received from the mobile device 23, 33b and/or from other sensor devices worn by Mark, e.g. the activity sensor mentioned above.

The artificial coach further asks Justin: “Do you want me to connect you to him?”. Depending on the exceptional circumstance, Justin may request to be connected to Mark during the training session and may communicate with him through a message such as “Hi Mark! I noticed that you were training bit too hard. Take it back a notch”.

Furthermore, after a training session, when Mark completed the training, the fitness agent apparatus 20, 30 (or the artificial coach) detects that the activity has stopped and stores the fitness data.

Next, the fitness agent apparatus 20, 30 (or the artificial coach) evaluates the fitness data and the training instruction data and may send a message to Mark such as “You did great, exactly as planned!” and may notify Justin with a message such as “Mark has completed the training” and provides him with the fitness data.

Furthermore, Justin analyzes the fitness data, and may adjust the training instruction program, accordingly and may further send a message to Mark such as “I noticed that your heart rate was bit high in the last training. I adjusted the training program”.

In another example, the fitness agent apparatus 20, 30 (or the artificial coach) analyzes the training data of different users and may send a message to Justin such as “I noticed that Mark's performance have not been improved as expected”, then Justin modifies the training instruction program, accordingly and may send a message to Mark, such as “Hi Mark, I made some modifications to the training plan so you can reach your targets better”.

As discussed above, the artificial coach learns by analyzing the training instruction data received from the coach device and the fitness data received from the mobile device. Moreover, the artificial coach may also analyze the communication and may thereby be improved.

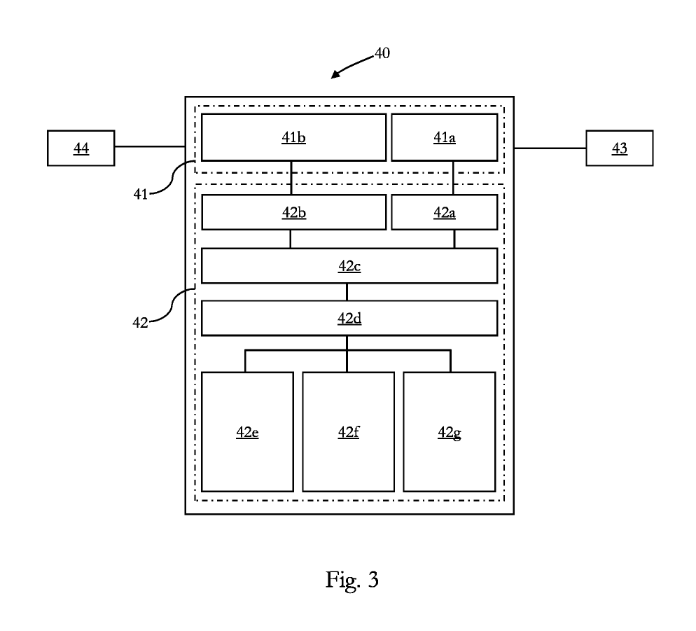

As illustrated in FIG. 3, in some embodiments, a fitness agent apparatus 40 includes one or more programs, which can be computer programs, application programs and the like.

In the following, the interplay of the fitness agent apparatus 40 having an interface 41, and an artificial intelligence unit 42, a user device 43 and a coach device 44 is discussed.

The fitness agent apparatus 40 may be a platform for several programs/applications, which handle the fitness data from the user devices 43 and the training instruction data from the real personal coach device 44 and may provide an artificial coach, as also discussed above.

The interface 41 in the fitness agent apparatus 40 may implement two programs, first program 41a for obtaining the fitness data from the user device 43 and a second application/program 41b for obtaining the training instruction data from the coach device 44, which handles obtaining different types of data from the coach device 44.

The data obtained by programs 41a and 41b are transmitted to the artificial intelligence unit 42, e.g. over an internal bus system, or other connection.

In some embodiments, the interface 41 may transmit the fitness data to a real personal coach device 44, hence, the real personal coach can see the training progress of a user over real time, as discussed above.

Moreover, several applications/programs are installed on the artificial intelligence unit 42.

In FIG. 3, exemplary applications 42a, 42b, 42c, 42d, 42e, 42f and 42g are installed on the artificial intelligence unit 42 for monitoring and processing of the fitness data and the training instruction data, simulating a real personal coach by the artificial coach, generating and providing a personalized training plan, providing (generating) the fitness beacon and monitoring the training progress by the fitness agent apparatus 40.

The fitness data from the user device 43 and the training instruction data from the coach device 44 are transmitted to the artificial intelligence unit 42 by the corresponding programs 41a and 41b, respectively. Furthermore, two applications of 42a and 42b are used for monitoring the fitness data and the training instruction data correspondingly.

The artificial intelligence unit 42 further includes additional application 42c for processing the fitness data and/or training instruction data, and determining a training progress based on the fitness data and the training instruction data. In some embodiments the application 42c evaluates the fitness data for determining a training status.

The data processed by application 42c is transmitted to application 42d for providing the artificial coach, which is able to simulate a real personal coach, wherein the application 42d is configured to provide the simulation of the real personal coach.

Furthermore, the artificial intelligence unit 42 includes an application 42e for generating and providing a personalized training plan.

The artificial intelligence unit 42 further includes additional application 42f for providing or generating a personalized fitness beacon. The generated personalized fitness beacon by 42f is further transmitted to the user device 43, which then, for example, may output an instruction stored in the fitness beacon upon detection of a training event in the fitness beacon, as discussed above.

Moreover, the artificial intelligence unit 42 may further include an application 42g for monitoring the training progress of the user and providing feedbacks to the user.

In the following, an example for the (personalized) fitness beacon selection is discussed, wherein the arbitrary user Mark decides to perform a training such as jogging in a nearby park.

The fitness agent apparatus 40 communicate with the coach device 44 and the real personal coach (via its interface), wherein the real personal coach provide the training instruction data.

Next, the fitness agent apparatus 40 analyzes the fitness data and the training instruction data, simulates an artificial coach with the aid of the application 42f on the artificial intelligence unit 42 and provides a personalized fitness beacon.

The personalized fitness beacon can be (directly) selected by a real personal coach. The exemplary personalized fitness beacon during a jogging in a park may include a combination of the fitness beacons based on the fitness data, the training instruction data and the simulated real personal coach, such as;

an exemplary personalized fitness beacon 1 may alert the real personal coach when the user reaches a certain point during the training, wherein the fitness beacon 1 includes the certain point as trigger event and if the certain point is reached, the real personal coach is alert (trigger condition and instruction).

An exemplary personalized fitness beacon 2 may play a pre-recorded message from the real personal coach such as “You are now approaching a steep hill. Remember what we discussed about the climbing techniques, and distribution of power”, wherein this is the instruction, the trigger event of the training is the steep hill and the trigger condition is detecting that the user reaches the steep hill.

Moreover, the personalized fitness beacon may include a control flow statement such as an “If-then” statement in the following fitness beacons.

An exemplary personalized fitness beacon 3 is:

If: Current user heart rate <130 bpm
Then: Give a task (instruction) “Run 3 minutes with higher speed”
If: Current heart rate >130 bpm
Then: Give a task (instruction) “Cool down for 3 minutes”.

And an exemplary personalized fitness beacon 4 is:

If: average running phase >6:00 min/km and current heart rate <140 bpm
Then: Give a task (instruction) “Run 3 minutes with higher speed”
If: Average running phase <6:00 min/km or current heart rate >140 bpm
Then: Give a task (instruction) “Cool down for 3 minutes”.

Hence, the fitness beacon may include different training instructions for different current training events including the fitness status of the user and or for different training situations (location, weather, etc.).

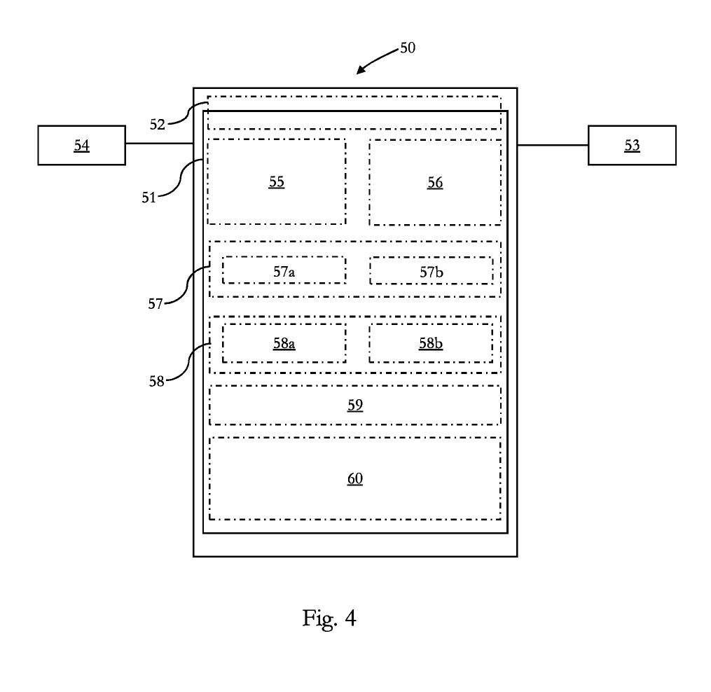

FIG. 4 illustrates a fitness agent apparatus 50, which may also form the basis for an electronic circuit, a smartphone, a server, a computer or the like, as discussed above.

The fitness agent apparatus 50, has a display 51, and an interface 52, and may be connected to a user device 53 and a real personal coach device 54, as discussed above. Moreover, the agent apparatus 50 has a processor 55, a storage 56, an artificial intelligence circuit 57, a personalized training plan circuit 58, a fitness beacon selection circuit 59 and an application circuit 60, wherein entities 57 to 60 may communicate with 55 and/or 60 over an internal bus or the like for communicating information.

The artificial intelligence circuit 57 has an artificial coach unit 57a, which may include on a processor, logic circuits and the like, and an interface 57b over which it can communicate to the artificial coach and/or to obtain the fitness data from the user device 53 and the training instruction data from the real personal coach device 54.

The personalized training plan circuit 58 has a personalized training plan generator 58a which generates a personalized training plan in cooperation with the simulated artificial coach, and based on the fitness data and the training instruction data. Moreover, the circuit has an interface 58b over which it can communicate the personalized training plan and/or receive the artificial coach data, the fitness data from the user device 53 and the training instruction data from the real personal coach device 54.

The fitness beacon selection circuit 59 may include a processor, a logic circuit and the like, and it may be specifically designed for providing personalized fitness beacon e.g. an executable code that express preformation of a specific action to be carry out such as an “If-then” control flow statement, as it discussed above.

The application circuit 60 may include a processor, logic circuits and the like, and it may be specifically designed for performing applications.

As discussed above, the applications running on the application circuit provide the personalized training plan and the personalized fitness beacon, wherein the personalized training plan circuit generates personalized training plan with 58a, and receives the data through the interface 58b.

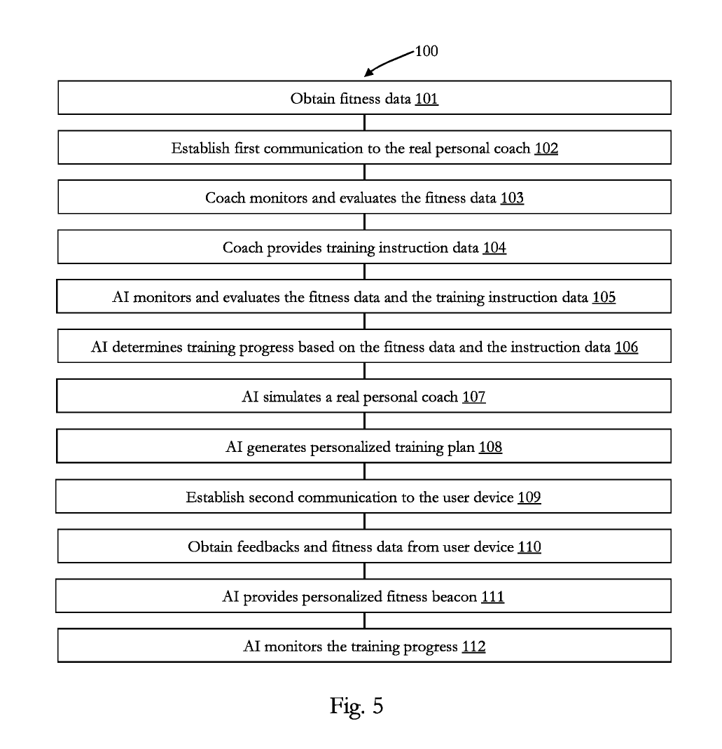

A method for controlling an electronic device, such as a fitness agent apparatus 10, 20, 30, 40 and 50 as discussed above, is described in the following and under reference of FIG. 5. The method can also be implemented as a computer program causing a computer and/or a processor and/or circuitry, to perform the method, when being carried out on the computer and/or processor and/or circuitry. In some embodiments, also a non-transitory computer-readable recording medium is provided that stores therein a computer program product, which, when executed by a processor, such as the processor described above, causes the method described to be performed.

FIG. 5 illustrates a flow diagram for providing the personalized training plan by an artificial coach based on the obtained fitness data from the user device and the training instruction data from the real personal coach device.

In the following, a method 100 for providing the personalized training plan is discussed, which can be performed by a fitness agent apparatus (e.g. 10, 20, 30, 40 or 50), as described herein, wherein, without limiting the disclosure in this regard, the discussion is exemplary focused on fitness agent apparatus 40.

At 101, the fitness data are obtained from at least one user device, e.g. 33a, 33b, 33c of FIG. 2 or 43 of FIG. 3, as discussed above. The fitness data may be obtained by application 41a running on the interface circuit 41, as discussed above. As mentioned, the fitness data may be obtained before, during or after training. Furthermore, the fitness data may be obtained during in-house training or outdoor training, as discussed above.

At 102, the interface 41 establishes first communication to the real personal coach device e.g. 34 in FIG. 2 or 44 in FIG. 3, running on an apparatus, (e.g. smartphone, tablet, etc.), as discussed above.

At 103, the obtained fitness data may be displayed, monitored and evaluated by a real personal coach e.g. 34 in FIG. 2 or 44 in FIG. 3, as discussed above.

At 104, the training instruction data are provided by the real personal coach based on the obtained fitness data, and, thus, are obtained over the interface of the fitness agent apparatus, as discussed above. The training instruction data may be obtained by the application 41b running on interface circuit 41, as discussed above.

At 105, the fitness data and the training instruction data are transmitted to the artificial intelligence unit (e.g. 42). The fitness data and the training instruction data may be obtained by applications 42a and 42b running on the artificial intelligence unit 42, respectively. Furthermore, the obtained data may be monitored, displayed and evaluated by corresponding applications 42a and 42b, respectively, as discussed above.

At 106, the artificial intelligence unit 42 determines a training progress based on the obtained fitness data from the user device and the training instruction data from the real personal coach device. The training progress may be determined by application 42c, running on the artificial intelligence unit 42, as discussed above.

At 107, the artificial intelligence unit 42 simulates an artificial coach similar to a real personal coach. The simulation may be performed by application 42d running on artificial intelligence unit 42, as discussed above.

At 108, the artificial intelligence unit 42 generates a personalized training plan based on the fitness data and the training instruction data. The generation of the personalized training plan may further be performed by applications 42d, running on the artificial intelligence unit 42, as discussed above.

At 109, the artificial intelligence unit 42 provides the generated personalized training plan to the interface 41, and the interface 41 establishes a second communication to the user device 43. The data may be provided by application 42e running on the artificial intelligence unit 42 and the communication may be performed by application 41a, running on interface 41 on the fitness agent apparatus 40, as discussed above.

At 110, the interface 41 obtains further fitness data and feedbacks from the user device, and the user health may be monitored. The obtained fitness data may be provided through application 41a, running on interface 41, and the monitoring may be performed through application 42a running on artificial intelligence unit 42, as discussed above.

At 111, the artificial intelligence unit 42 provides the personalized fitness beacon to the user device.

Selection of the personalized fitness beacon may be performed by the application 42f, running on the artificial intelligence unit 42, as discussed above. The user device may then output the instruction stored in the fitness beacon upon detection of the training event.

At 112, the artificial intelligence unit 42 monitors the training progress of the user. The monitoring of the training progress may be performed by application 42g running on the artificial intelligence unit 42, as discussed above.

In another embodiments, the user may decide to obtain the training instruction data directly from the real personal coach.

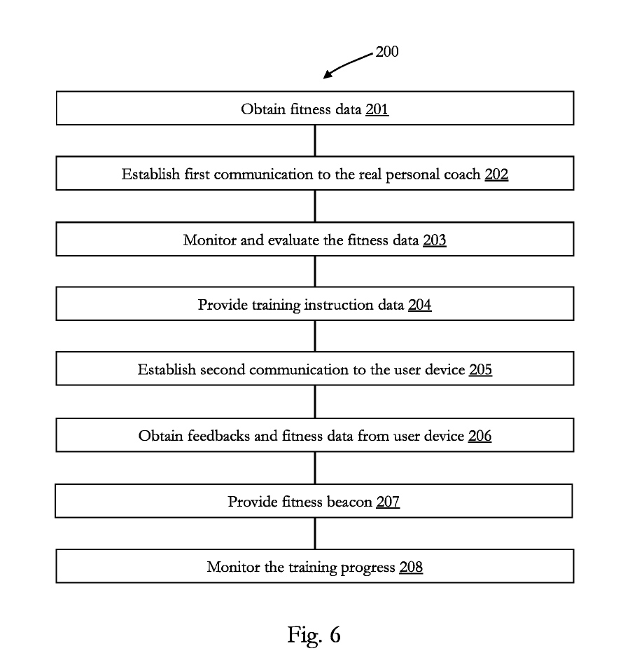

FIG. 6 shows a flowchart of a method 200, for generating training instruction data by the real personal coach.

At 201, the fitness data are obtained from at least one user device, e.g. 33a, 33b, 33c of FIG. 2 or 43 of FIG. 3, as discussed above, wherein, without limiting the disclosure in this regard, the discussion is exemplary focused on fitness agent apparatus 40. The fitness data may be obtained by application 41a running on the interface circuit 41, as discussed above. As mentioned, the fitness data may be obtained before, during or after training. Furthermore, the fitness data may be obtained during in-house training or outdoor training, as discussed above.

At 202, the interface 41 establishes a first communication to the real personal coach device e.g. 34 in FIG. 2 or 44 in FIG. 3, running on an apparatus, (e.g. smartphone, tablet, etc.), as discussed above.

At 203, the obtained fitness data may be displayed, monitored and evaluated by a real personal coach e.g. 34 in FIG. 3 or 44 in FIG. 4, as discussed above.

At 204, the training instruction data are provided by the real personal coach based on the obtained fitness data. The training instruction data may be obtained by application 41b running on the interface circuit 41, as discussed above.

At 205, the interface 41 establishes a second communication to the user device 43 and the training instruction data are provided. The communication may be performed by application 41a, running on the interface 41 on the fitness agent apparatus 40, as discussed above.

At 206, the interface obtains additional fitness data and feedbacks from the user device. The obtained fitness data may be provided through application 41a, running on interface 41, as discussed above.

At 207, the real personal coach provides the personalized fitness beacon to the user device over the fitness agent apparatus. The personalized fitness beacon is selected by a real personal coach and it may be provided to user through applications 41b and 41a, respectively, running on interface 41, as discussed above. As mentioned, the user device than may output the instruction stored in the fitness beacon upon detection of the training event stored in the fitness beacon.

At 208, the real personal coach monitors the training progress of the user. The monitoring of the training progress may be performed by coach device 44, as discussed above.

In another embodiment, the real personal coach may not be available, in such a case, the artificial intelligence coach carries out the role of a real personal coach and provides the personalized training plan.

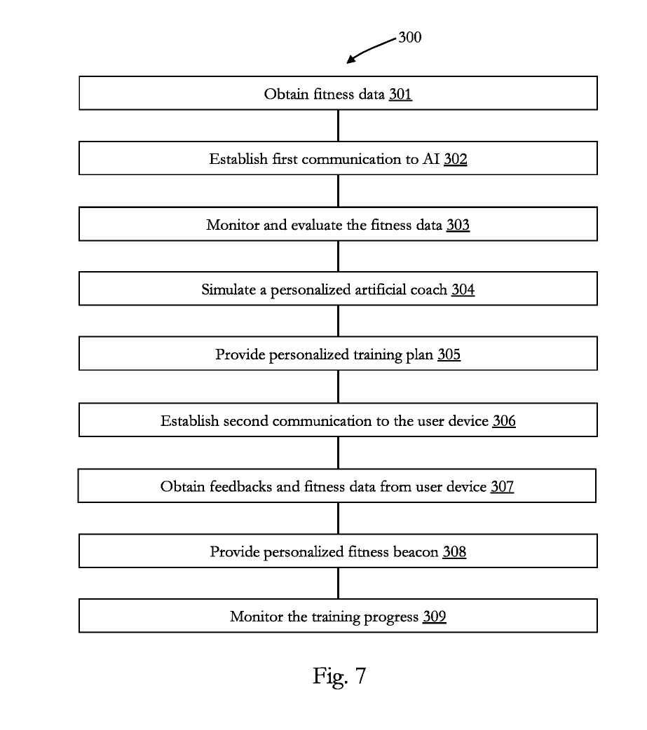

FIG. 7 shows a flowchart of a method 300, for generating the personalized training plan by the artificial coach when the real personal coach is not available.

At 301, the fitness data are obtained from at least one user device, e.g. 33a, 33b, 33c of FIG. 2 or 43 of FIG. 3, as discussed above, wherein, without limiting the disclosure in this regard, the discussion is exemplary focused on fitness agent apparatus 40. The fitness data may be obtained by application 41a running on the interface circuit 41, as discussed above. As mentioned, the fitness data may be obtained before, during or after training. Furthermore, the fitness data may be obtained during in-house training or outdoor training, as discussed above.

At 302, the interface 41 establishes a first communication to the artificial intelligence unit 42 in FIG. 3, as discussed above. The communication may be performed by application 41a, on the interface circuit 41, as discussed above.

At 303, the obtained fitness data is transmitted to artificial intelligence unit 42. The fitness data may be obtained by application 42a running on artificial intelligence unit 42. Furthermore, the data may be monitored, displayed and evaluated by application 42a, as discussed above.

At 304, the artificial intelligence unit 42 simulates an artificial coach similar to a real personal coach, in order to generate a personalized training plan. The simulation may be performed by application 42d running on the artificial intelligence unit 42, as discussed above.

At 305, the artificial intelligence unit 42 generates a personalized training plan based on the fitness data. The generation of the personalized training plan may further be performed by application 42d, running on the artificial intelligence unit 42. Furthermore, the artificial intelligence unit 42 provides the interface 41 with the personalized training plan. The data may be provided by application 42e running on artificial intelligence unit 42.

At 306, the interface 41 establishes a second communication to the user device 43. The communication may be performed by application 41a, running on the interface circuit 41, as discussed above.

At 307, the interface 41 obtains further fitness data and feedbacks from the user device, and the user health may be monitored. The obtained fitness data may be provided through application 41a, running on the interface 41, and the user health monitoring may be performed through application 42a running on the artificial intelligence unit 42, as discussed above.

At 308, the artificial intelligence unit 42 provides the personalized fitness beacon to the user device. Selection of the personalized fitness beacon may be performed by the application 42f, running on the artificial intelligence unit 42, as discussed above. As mentioned, the user device may output an instruction stored in the fitness beacon upon detection of a training event stored in the fitness beacon.

At 309, the artificial intelligence unit 42 monitors the training progress. The training progress monitoring may be performed by application 42g running on artificial intelligence unit 42, as discussed above.

It should be recognized that the embodiments describe methods with an exemplary ordering of method steps. The specific ordering of method steps is however given for illustrative purposes only and should not be construed as binding. For example the ordering of 111 (providing personalized fitness beacon) and 112 (monitoring the training progress) in the embodiment of FIG. 5 may be exchanged. In addition, the ordering of 206 (obtaining feedbacks and fitness data), 207 (providing fitness beacon) and 208 (monitoring the training progress) in the embodiment of FIG. 6 may be exchanged. Other changes of the ordering of method steps may be apparent to the skilled person.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An agent apparatus comprising:
an interface configured to obtain fitness data and training instruction data; and
an artificial intelligence unit configured to provide an artificial coach by analyzing the fitness data and the training instruction data.
   (2) The agent apparatus of (1), wherein the artificial intelligence unit is further configured to provide a training plan.
   (3) The agent apparatus of (1) or (2), wherein the artificial intelligence unit is further configured to provide an instruction, based on a fitness beacon.
   (4) The agent apparatus of (3), wherein the fitness beacon includes the instruction and a training event, wherein the instruction is associated with the training event.
   (5) The agent apparatus of (4), wherein the instruction is provided, when the training event is detected.
   (6) The agent apparatus of (5), wherein the training event includes at least one of: location, point of time, training exercise, fitness route, fitness program, fitness activity, weather condition, presence of person.
   (7) The agent apparatus of anyone of (1) to (6), wherein providing the artificial coach comprises providing the fitness data and the training instruction data to a machine learning algorithm.
   (8) The agent apparatus of anyone of (1) to (7), wherein the artificial intelligence unit is further configured to determine a training progress based on the fitness data and the training instruction data.
   (9) The agent apparatus of anyone of (1) to (8), wherein the artificial intelligence unit is further configured to evaluate the fitness data for determining a fitness progress.
   (10) The agent apparatus of anyone of (1) to (9), wherein the artificial coach monitors the fitness data for determining a training status.
   (11) An agent method, comprising:
obtaining fitness data and training instruction data; and
providing an artificial coach by analyzing the fitness data and the training instruction data.
   (12) The agent method of (11), further comprising providing a training plan.
   (13) The agent method of (11) or (12), further comprising providing an instruction, based on a fitness beacon.
   (14) The agent method of (13), wherein the fitness beacon includes the instruction and a training event, wherein the instruction is associated with the training event.
   (15) The agent method of (14), wherein the instruction is provided, when the training event is detected.
   (16) The agent method of (15), wherein the training event includes at least one of: location, point of time, training exercise, fitness route, fitness program, fitness activity, weather condition, presence of person.
   (17) The agent method of anyone of (11) to (16), wherein providing the artificial coach comprises providing the fitness data and the training instruction data to a machine learning algorithm.
   (18) The agent method of anyone of (11) to (17), further comprising determining a training progress based on the fitness data and the training instruction data.
   (19) The agent method of anyone of (11) to (18), further comprising evaluating the fitness data for determining a fitness progress.
   (20) The agent method of anyone of (11) to (19), further comprising monitoring the fitness data for determining a training status.
   (21) A computer program comprising program code causing a computer to perform the method according to anyone of (11) to (20), when being carried out on a computer.
   (22) A non-transitory computer-readable recording medium that stores therein a computer program product, which, when executed by a processor, causes the method according to anyone of (11) to (20) to be performed.
   (23) An agent apparatus comprising circuitry configured to perform the agent method of anyone of (11) to (20).

The present application claims priority to European Patent Application 17163069.2 filed by the European Patent Office on 27 Mar. 2017, the entire contents of which being incorporated herein by reference.

1. An agent apparatus comprising:
an interface configured to obtain fitness data and training instruction data; and
an artificial intelligence unit configured to provide an artificial coach by analyzing the fitness data and the training instruction data.

2. The agent apparatus of claim 1, wherein the artificial intelligence unit is further configured to provide a training plan.

3. The agent apparatus of claim 1, wherein the artificial intelligence unit is further configured to provide an instruction, based on a fitness beacon.

4. The agent apparatus of claim 3, wherein the fitness beacon includes the instruction and a training event, wherein the instruction is associated with the training event.

5. The agent apparatus of claim 4, wherein the instruction is provided, when the training event is detected.

6. The agent apparatus of claim 5, wherein the training event includes at least one of: location, point of time, training exercise, fitness route, fitness program, fitness activity, weather condition, presence of person.

7. The agent apparatus of claim 1, wherein providing the artificial coach comprises providing the fitness data and the training instruction data to a machine learning algorithm.

8. The agent apparatus of claim 1, wherein the artificial intelligence unit is further configured to determine a training progress based on the fitness data and the training instruction data.

9. The agent apparatus of claim 1, wherein the artificial intelligence unit is further configured to evaluate the fitness data for determining a fitness progress.

10. The agent apparatus of claim 1, wherein the artificial coach monitors the fitness data for determining a training status.

11. An agent method, comprising:
obtaining fitness data and training instruction data; and
providing an artificial coach by analyzing the fitness data and the training instruction data.

12. The agent method of claim 11, further comprising providing a training plan.

13. The agent method of claim 11, further comprising providing an instruction, based on a fitness beacon.

14. The agent method of claim 13, wherein the fitness beacon includes the instruction and a training event, wherein the instruction is associated with the training event.

15. The agent method of claim 14, wherein the instruction is provided, when the training event is detected.

16. The agent method of claim 15, wherein the training event includes at least one of: location, point of time, training exercise, fitness route, fitness program, fitness activity, weather condition, presence of person.

17. The agent method of claim 11, wherein providing the artificial coach comprises providing the fitness data and the training instruction data to a machine learning algorithm.

18. The agent method of claim 11, further comprising determining a training progress based on the fitness data and the training instruction data.

19. The agent method of claim 11, further comprising evaluating the fitness data for determining a fitness progress.

20. The agent method of claim 11, further comprising monitoring the fitness data for determining a training status.
